(19) United States
(12) Patent Application Publication
(10) Pub. No.: US 2017/0214540 A1
(43) Pub. Date: Jul. 27, 2017

(54) MOBILE TERMINAL-BASED METHODS OF CONTROLLING SMART HOME APPLIANCES, AND ASSOCIATED MOBILE TERMINALS AND ACCESSORIES

(71) Applicant: Huizhou TCL Mobile Communication Co., Ltd, Huizhou City, Guangdong (CN)

(72) Inventors: Song WANG, Huizhou City, Guangdong (CN); Yu ZHENG, Huizhou City, Guangdong (CN)

(73) Assignee: Huizhou TCL Mobile Communication Co., Ltd, Huizhou City, Guangdong (CN)

(21) Appl. No.: 15/315,315

(22) PCT Filed: Mar. 16, 2016
(86) PCT No.: PCT/CN2016/076482

§ 371 Date: Nov. 30, 2016

(30) Foreign Application Priority Data
Jul. 14, 2015 (CN) 201510412731.1

(51) Int. Cl. H04L 12/28; H04L 29/08; G05B 15/02; H04B 1/3827

(52) U.S. Cl. CPC H04L 12/282; H04L 12/2827; H04B 1/3827; H04L 67/2842; G05B 15/02; H04L 2012/2841; H04L 2012/2849; G05B 2219/2642; G05B 2219/23316

(57) ABSTRACT

Mobile terminal-based methods of controlling smart home appliances, and associated mobile terminals and accessories are disclosed. The method includes: receiving, at a mobile terminal, current state information of a user, the state information being determined by an accessory of the mobile terminal based on its monitored user's sign parameters or environmental parameters in combination with correspondences between the user sign parameters or environmental parameters and states of the user; obtaining an operating mode of at least one smart home appliance; determining whether the operating mode of the at least one smart home appliance matches with the current user state; and adjusting the operating mode of the at least one smart home appliance to a corresponding operating mode of the current user state, if the operating mode of the at least one smart home appliance doesn't match with the current user state.

### CROSS-REFERENCE TO RELATED APPLICATIONS

The present application is a 35 U.S.C. §371 National Phase conversion of International (PCT) Patent Application No. PCT/CN2016/076482 filed Mar. 16, 2016, which claims foreign priority of Chinese Patent Application No. 201510412731.1, filed on Jul. 14, 2015 in the State Intellectual Property Office of China, the content of which is hereby incorporated by reference.

### TECHNICAL FIELD

The present disclosure relates generally to communication technologies, and in particular relates to mobile terminal-based methods of controlling smart home appliances, and associated mobile terminals and accessories.

### BACKGROUND

A traditional home appliance is typically controlled through a power menu or a remote controller. While smart home control may include connecting a smart mobile terminal to smart home appliances and simulating the remote controller with the smart terminal.

However, in either case, the operating mode of the home appliances cannot be adjusted in real time. For example, if a user falls asleep while watching TV, then the TV, speakers, and lights may still work in the previous mode.

### SUMMARY

Embodiments of the present disclosure provide mobile terminal-based methods of controlling smart home appliances, and associated mobile terminals and accessories to adjust the operating mode of smart home appliances in real time.

There is provided a mobile terminal-based method of controlling smart home appliances, the method comprising: receiving, at a mobile terminal, state information of a user, the user state information being determined by an accessory of the mobile terminal based on its monitored user sign parameters or environmental parameters in combination with correspondences between the user sign parameters or environmental parameters and states of the user; obtaining an operating mode of at least one smart home appliance, the operating mode comprising a normal mode and sleep mode; determining whether the operating mode of the at least one smart home appliance matches with the user state, the user states having an one-to-one correspondence with the operating modes of the at least one smart home appliance; and adjusting the operating mode of the at least one smart home appliance to a corresponding operating mode of a current user state based on the user state information, if the operating mode of the at least one smart home appliance doesn't match with the user state.

Adjusting the operating mode of the at least one smart home appliance based on the user state information may comprise: when the user is in a sleep state while the at least one smart home appliance is in the normal mode, adjusting the operating mode of the at least one smart home appliance to the sleep mode.

Adjusting the operating mode of the at least one smart home appliance based on the user state information may further comprise: when the user is in a non-sleep state while the at least one smart home appliance is in the sleep mode, adjusting the operating mode of the at least one smart home appliance to the normal mode.

The at least one smart home appliance may comprise one or more of a TV, speakers, and lights. Adjusting the operating mode of the at least one smart home appliance to the sleep mode may comprise: turning down a volume of the TV or speakers, or reducing a brightness of the lights.

There is also provided a mobile terminal-based method of controlling smart home appliances, the method comprising: monitoring, by an accessory of a mobile terminal, a user's sign parameters or environmental parameters; determining a state of the user based on the user sign parameters or environmental parameters; and transmitting the user state information to the mobile terminal, so that the mobile terminal may determine whether to adjust an operating mode of at least one smart home appliance based on the user state information.

Determining the user state based on the user sign parameters or environmental parameters may comprise: determining the user state based on the user sign parameters or environmental parameters in combination with correspondences between the user sign parameters or environmental parameters and states of the user.

Transmitting the user state information to the mobile terminal may comprise: transmitting the user state information to the mobile terminal in real time or periodically according to a predetermined period, or transmitting the user state information when determining that the user state changes.

There is also provided an associated mobile terminal that comprises a transceiver, a memory, and a processor. The transceiver may be configured to receive state information of a user, the user state information being obtained through an accessory of the mobile terminal monitoring the user's sign parameters or environmental parameters. The memory may be configured to store the related data. The processor may be configured to: obtain an operating mode of at least one smart home appliance; determining whether the operating mode of the at least one smart home appliance matches with the user state, the user states having an one-to-one correspondence with the operating modes of the at least one smart home appliance; and adjust the operating mode of the at least one smart home appliance based on the user state information when determining the operating mode of the at least one smart home appliance doesn't match with the user state.

The processor may be configured to adjust the operating mode of the at least one smart home appliance to a sleep mode if the user is in a sleep state while the at least one smart home appliance is in a normal mode.

The processor may be configured to adjust the operating mode of the at least one smart home appliance to a normal mode if the user is in a non-sleep state while the at least one smart home appliance is in a sleep mode.

The at least one smart home appliance may comprise one or more of a TV, speakers, and lights. The processor may be configured to, when the user is in the sleep state, turn down a volume of the TV or speakers, or reduce a brightness of the lights.

There is also provided an accessory of a mobile terminal, the accessory comprising a transceiver and a processor. The processor may be configured to: monitor a user's sign parameters or environmental parameters; and determine a state of the user based on the user sign parameters or environmental parameters. The transceiver may be configured to transmit the user state information determined by the processor to the mobile terminal, so that the mobile terminal may determine whether to adjust an operating mode of at least one smart home appliance based on the user state information.

The processor may be configured to determine the user state based on the user sign parameters or environmental parameters in combination with correspondences between the user sign parameters or environmental parameters and states of the user.

The transceiver may be configured to transmit the user state information to the mobile terminal in real time or periodically according to a predetermined period, or transmit the user state information when determining the user state changes.

According to the above solutions, the mobile terminal can determine whether the operating mode of a smart home appliance matches with the user state, and, if they don't match, adjust the operating mode of the smart home appliance to a corresponding operating mode of the current user state. Thus, the operating mode of the smart home appliance can be adjusted in real time in accordance with the user state.

As such, the present disclosure can improve the energy efficiency and at the same time provide a suitable and comfortable environment for the user.

### BRIEF DESCRIPTION OF THE DRAWINGS

FIG. 1 is a flowchart illustrating a mobile terminal-based method of controlling smart home appliances according an embodiment of the disclosure.

FIG. 2 is a flowchart illustrating a mobile terminal-based method of controlling smart home appliances according another embodiment of the disclosure.

FIG. 3 is a block diagram of a mobile terminal according to an embodiment of the disclosure.

FIG. 4 is a block diagram of an accessory of a mobile terminal according to an embodiment of the disclosure.

FIG. 5 is a block diagram of a mobile terminal according to another embodiment of the disclosure.

FIG. 6 is a block diagram of an accessory of a mobile terminal according to another embodiment of the disclosure.

### DETAILED DESCRIPTION

For a thorough understanding of the disclosure, numerous specific details are set forth in the following description for purposes of illustration but not of limitation, such as particularities of system structures, interfaces, techniques, et cetera.

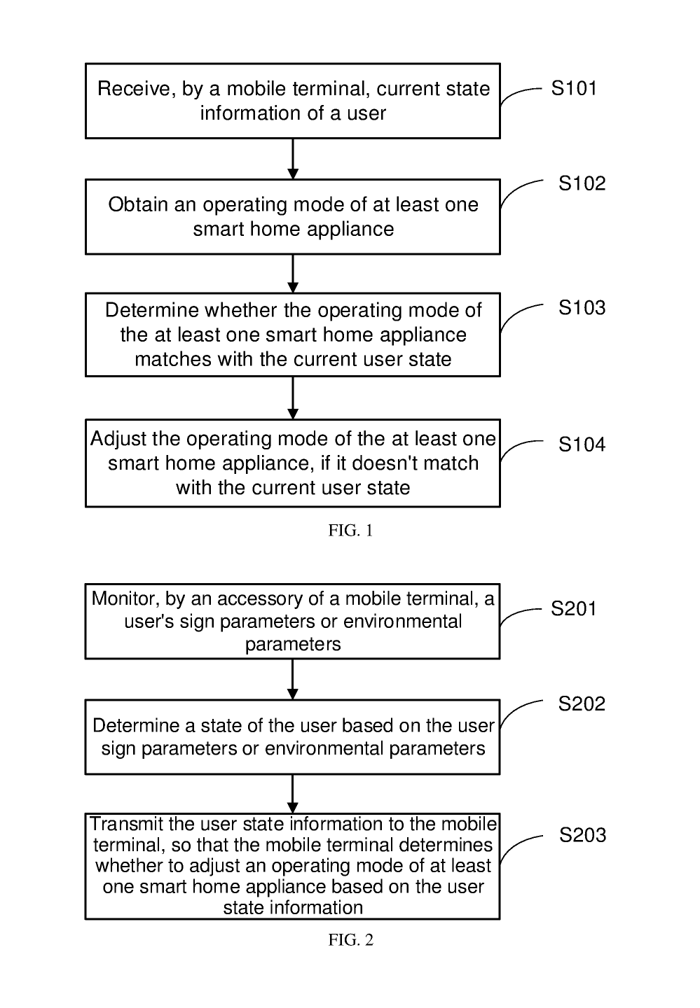

FIG. 1 shows a flowchart of a mobile terminal-based method of controlling smart home appliances according to an embodiment of the disclosure. The method can be performed by a mobile terminal which is in a physical or wireless connection with an accessory and so receives state information of a user transmitted from the accessory. The method may comprise the following blocks.

In S101, the mobile terminal may receive the user state information from the accessory, the user state information being obtained through the accessory monitoring the user's sign parameters or environmental parameters.

After a communication connection is established between the mobile terminal and the accessory, the mobile terminal may receive the current state information of the user from the accessory. The user state information may be used to identify the state the user is currently in. The user state information may be obtained through the accessory monitoring the user's sign parameters or the environmental parameters. The user's current state may comprise sleep, non-sleep, et cetera.

The accessory of the mobile terminal may comprise, but is not limited to, a wearable device, or a device capable of monitoring the user sign parameters or the environmental parameters.

It will be appreciated that the accessory can transmit the user's current state information to the mobile terminal in real time or periodically according to a predetermined period, or transmit the current state information when detecting a change in the user state.

In S102, the method may include obtaining an operating mode of at least one smart home appliance.

The mobile terminal may obtain the operating mode of the at least one smart home appliance. The at least one smart home appliance may comprise, but is not limited to, one or more of a TV, speakers, and lights. Other smart home appliances can also be included, such as an air conditioner. The operating mode may comprise a normal mode and sleep mode.

Note blocks S101 and S102 can be executed in any order, for example, in parallel.

In S103, the method may include determining whether the operating mode of the at least one smart home appliance matches with the user state.

After obtaining the user's current state information and the operating mode of the at least one smart home appliance, the mobile terminal may determine whether the operating mode of the at least one smart home appliance matches with the user state. The user states may have a one-to-one correspondence with operating modes of the at least one smart home appliance. For example, when the user is in a non-sleep state, the corresponding operating mode of the at least one smart home appliance would be the normal mode. In contrary, when the user is in a sleep state, the corresponding operating mode of the at least one smart home appliance would be the sleep mode.

When the mobile terminal determines the operating mode of the at least one smart home appliance doesn't match with the user state, block S104 will be turned to; otherwise, no operation will be performed.

In S104, if the operating mode of the at least one smart home appliance doesn't match with the user state, the operating mode of the at least one smart home appliance may be adjusted based on the user state information.

After determining the operating mode of the at least one smart home appliance doesn't match with the user state, the mobile terminal may adjust the operating mode of the at least one smart home appliance to a corresponding operating mode of the current user state.

In particular, when the user is in the sleep state, the operating mode of the at least one smart home appliance will be adjusted to the sleep mode.

For example, when the user is in the sleep state while the at least one smart home appliance is in the normal mode, the operating mode of the at least one smart home appliance then may be converted from the normal mode to the sleep mode.

In contrary, when the user is in the non-sleep state while the at least one smart home appliance is in the sleep mode, the operating mode of the at least one smart home appliance then may be switched from the sleep mode to the normal mode.

Further, if the at least one smart home appliance comprises one or more of a TV, speakers, and lights, then adjusting the operating mode of the at least one smart home appliance to the sleep mode when the user is in the sleep state may comprise: turning down a volume of the TV or speakers, or reducing a brightness of the lights.

For example, when the user is in the sleep state, the volume of the TV and speakers may be turned down, and the brightness of the lights may be reduced. Alternatively, all of the TV, speakers, and lights may be completely turned off.

According to the above embodiment, the mobile terminal can determine whether the operating mode of a smart home appliance matches with the user state, and, if they don't match, adjust the operating mode of the smart home appliance to a corresponding operating mode of the current user state. Thus, the operating mode of the smart home appliances can be adjusted in real time in accordance with the user state.

As such, the present embodiment can improve the energy efficiency and at the same time provide a suitable and comfortable environment for the user.

FIG. 2 shows a flowchart of a mobile terminal-based method of controlling smart home appliances according to another embodiment of the disclosure. The method can be performed by an accessory of a mobile terminal, the accessory being in a physical or wireless connection with the mobile terminal and so transmitting state information of a user to the mobile terminal. The method may comprise the following blocks.

In S201, the accessory may monitor the user's sign parameters or environmental parameters.

The accessory may use a sensor or the like to monitor the user sign parameters or environmental parameters.

The accessory of the mobile terminal may comprise, but is not limited to, a wearable device, or a device capable of monitoring the user sign parameters or environmental parameters.

In S202, the method may include determining a state of the user based on the user sign parameters or the environmental parameters.

After detecting the user sign parameters or the environmental parameters, the accessory can determine the state of the user based thereon.

Further, the user state may be determined based on the user sign parameters or environmental parameters in combination with correspondences between the user sign parameters or environmental parameters and states of the user.

For example, the accessory may refer to a database to determine the user state corresponding to the user sign parameters or the environmental parameters.

The data base may store in advance the correspondences between the user sign parameters or environmental parameters and the user states, or may contain a survey report of the correspondences between the user sign parameters or environmental parameters with the user states.

In S203, the user state information may be transmitted to the mobile terminal, so that the mobile terminal may determine whether to adjust the operating mode of the at least one smart home appliance according to the user state information.

After determining the user state, the accessory may transmit the user state information to the mobile terminal, thus the mobile terminal can determine whether it needs to adjust an operating mode of at least one smart home appliance based on the user state information and the operating mode of the at least one smart home appliance.

It will be appreciated that the accessory can transmit the user's current state information to the mobile terminal in real time or periodically according to a predetermined period, or transmit the current state information when detecting a change in the user state.

According to the above embodiment, the accessory of the mobile terminal can determine the user's current state based on its monitored user sign parameters or environmental parameters, and transmit the user state information to the mobile terminal, so that the mobile terminal can determine whether to adjust the operating mode of the at least one smart home appliance based on the user state information. Thus, the mobile terminal can adjust the operating mode of the smart home appliances in real time in accordance with the user state, which is energy efficient and can at the same time provide a suitable and comfortable environment for the user.

FIG. 3 is a block diagram of a mobile terminal according to an embodiment of the disclosure. Various modules of the mobile terminal according to the present embodiment are configured to perform the corresponding blocks of the embodiment illustrated in FIG. 1; see FIG. 1 and relevant description for details. The mobile terminal may comprise a receiving module 310, an acquisition module 320, a determination module 330, and an adjustment module 340.

The receiving module 310 may be configured to receive state information of a user, the user state information being obtained through the accessory monitoring the user's sign parameters or environmental parameters.

The acquisition module 320 may be configured to obtain an operating mode of at least one smart home appliance.

The determination module 330 may be configured to determine whether the operating mode of the at least one smart home appliance matches with the user state. The user states may have a one-to-one correspondence with operating modes of the at least one smart home appliance. The determination module 330 may further be configured to transfer the determination result together with the user state information to the adjustment module 340.

The adjustment module 340 may be configured to receive the determination result and the user state information sent from the determination module 330, and, when the determination module 330 determines the operating mode of the at least one smart home appliance doesn't match with the user state information, adjust the operating mode of the at least one smart home appliance based on the user state information.

According to the above embodiment, the mobile terminal can determine whether the operating mode of a smart home appliance matches with the user state, and, if they don't match, adjust the operating mode of the smart home appliance to a corresponding operating mode of the current user state. Thus, the operating mode of the smart home appliance can be adjusted in real time in accordance with the user state.

In a particular embodiment, referring still to FIG. 3, the adjustment module 340 may be configured to adjust the operating mode of the at least one smart home appliance to a sleep mode when the user is in the sleep state.

For example, when the user is in a sleep state, the adjustment module 340 may be configured to adjust the operating mode of the at least one smart home appliance to the sleep mode.

The at least one smart home appliance may comprise one or more of a TV, speakers, and lights. The adjustment module 340 may be configured to, when the user is in the sleep state, turn down a volume of the TV or speakers, or reduce a brightness of the lights.

According to the above embodiment, the mobile terminal can determine whether the operating mode of a smart home appliance matches with the user state, and, if they don't match, adjust the operating mode of the smart home appliance to a corresponding operating mode of the current user state. Thus, the operating mode of the smart home appliance can be adjusted in real time in accordance with the user state.

As such, the present embodiment can improve the energy efficiency and at the same time provide a suitable and comfortable environment for the user.

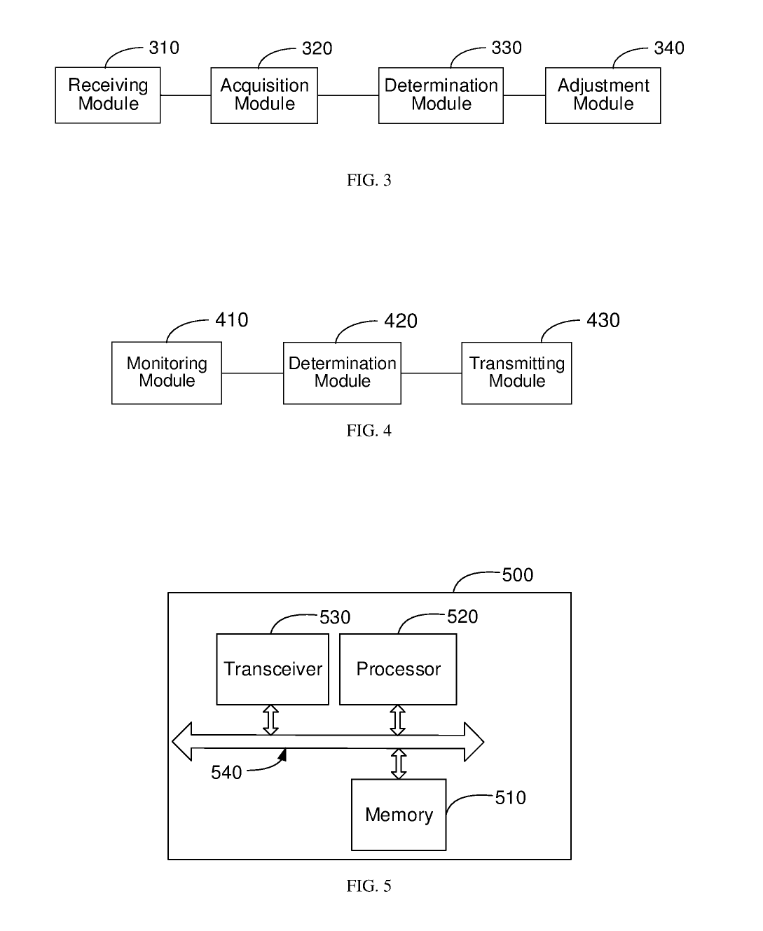

FIG. 4 is a block diagram of an accessory of a mobile terminal according to an embodiment of the disclosure. The accessory may comprise, but is not limited to, a wearable device, or a device capable of monitoring a user's sign parameters or environmental parameters. Various modules of the accessory according to the present embodiment are configured to perform the corresponding blocks of the embodiment illustrated in FIG. 2; see FIG. 2 and relevant description for details. The accessory may comprise a monitoring module 410, a determination module 420, and a transmitting module 430.

The monitoring module 410 may be configured to monitor the user's sign parameters or environmental parameters. The monitoring module 410 may further be configured to transfer the detected user sign parameters or environmental parameters to the determination module 420.

The determination module 420 may be configured to receive the user sign parameters or environmental parameters sent from the monitoring module 410, and determine a state of the user based on the user sign parameters or the environmental parameters.

Further, the determination module 420 may be configured to determine the user state based on the user sign parameters or environmental parameters in combination with the correspondences between the user sign parameters or environmental parameters and states of the user.

The determination module 420 may further be configured to transfer the user state information to the transmitting module 430.

The transmitting module 430 may be configured to receive the user state information transferred from the determination module 420, and transmit the user state information to the mobile terminal, so that the mobile terminal may determine whether to adjust an operating mode of at least one smart home appliance based on the user state information.

According to the above embodiment, the accessory of the mobile terminal can determine the user's current state based on its monitored user sign parameters or environmental parameters, and transmit the user state information to the mobile terminal, so that the mobile terminal can determine whether to adjust the operating mode of the at least one smart home appliance based on the user state information. Thus, the mobile terminal can adjust the operating mode of the smart home appliances in real time in accordance with the user state, which is energy efficient and can meanwhile provide a suitable and comfortable environment for the user.

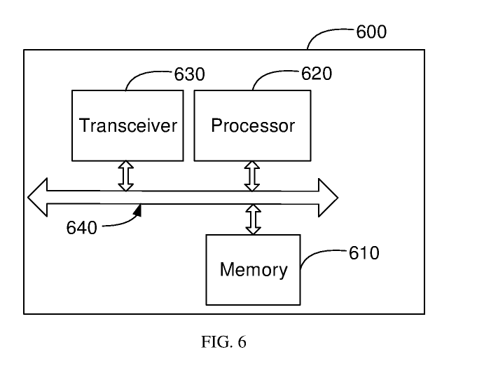

FIG. 5 is a block diagram of a mobile terminal according to another embodiment of the disclosure. The mobile terminal 500 may comprise a memory 510, a processor 520, a transceiver 530, and a bus 540. The processor 520 may be coupled to the memory 510 via the bus 540. The processor 520 may also be coupled to the transceiver 530 via the bus 540.

The transceiver 530 may be configured to receive and transmit data.

The memory 510 may store program instructions.

The processor 520 may be a Central Processing Unit (CPU) or a combination of CPU(s) and other hardware chips. The processor 520 may be configured to perform the following operations according to the program instructions stored in the memory 510:

control the transceiver 530 to receive state information of a user, the user state information being obtained through an accessory of the mobile terminal monitoring the user's sign parameters or environmental parameters;

obtain an operating mode of at least one smart home appliance, and determine whether the operating mode of the at least one smart home appliance matches with the user state, wherein states of the user may have an one-to-one correspondence with operating modes of the at least one smart home appliance; and

adjust the operating mode of the at least one smart home appliance based on the user state information if the operating mode of the at least one smart home appliance doesn't match with the user state.

Optionally, the processor 520 may be configured to adjust the operating mode of the at least one smart home appliance to a sleep mode if the user is in a sleep state while the at least one smart home appliance is in a normal mode.

Optionally, the processor 520 may be configured to adjust the operating mode of the at least one smart home appliance to a normal mode if the user is in a non-sleep state while the at least one smart home appliance is in a sleep mode.

Optionally, the at least one smart home appliance may comprise one or more of a TV, speakers, and lights. The processor 520 may be configured to, when the user is in the sleep state, turn down a volume of the TV or speakers, or reduce a brightness of the lights.

According to the above embodiment, the mobile terminal can determine whether the operating mode of a smart home appliance matches with the user state, and, if they don't match, adjust the operating mode of the smart home appliance to a corresponding operating mode of the current user state. Thus, the operating mode of the smart home appliance can be adjusted in real time in accordance with the user state.

As such, the present embodiment can improve the energy efficiency and meanwhile provide a suitable and comfortable environment for the user.

FIG. 6 is a block diagram of an accessory of a mobile terminal according to another embodiment of the disclosure. The accessory may comprise, but is not limited to, a wearable device, or a device capable of monitoring a user's sign parameters or the environmental parameters. The accessory 600 may comprise a memory 610, a processor 620, a transceiver 630, and a bus 640. The processor 620 may be coupled to the memory 610 via the bus 640. The processor 620 may also be coupled to the transceiver 630 via the bus 640.

The transceiver 630 may be configured to receive and transmit data.

The memory 610 may store program instructions.

The processor 620 may be a Central Processing Unit (CPU) or a combination of CPU(s) and other hardware chips. The processor 620 may be configured to perform the following operations according to the program instructions stored in the memory 610:

monitor the user's sign parameters or environmental parameters, and determine a state of the user based on the user sign parameters or environmental parameters;

control the transceiver 630 to transmit the user state information determined by the processor 620 to the mobile terminal, so that the mobile terminal may determine whether to adjust an operating mode of at least one smart home appliance according to the user state information.

Optionally, the processor 620 may be configured to determine the user state based on the user sign parameters or environmental parameters in combination with correspondences between the user sign parameters or environmental parameters and states of the user.

Optionally, the processor 620 may be configured to control the transceiver 630 to transmit the user state information to the mobile terminal in real time or periodically according to a predetermined period, or transmit the user state information when determining the user state changes.

According to the above embodiment, the accessory of the mobile terminal can determine the user's current state based on its monitored user sign parameters or environmental parameters, and transmit the user state information to the mobile terminal, so that the mobile terminal can determine whether to adjust the operating mode of the at least one smart home appliance based on the user state information. Thus, the mobile terminal can adjust the operating mode of the smart home appliances in real time in accordance with the user state, which is energy efficient and can at the same time provide a suitable and comfortable environment for the user.

For a thorough understanding of the disclosure, numerous specific details are set forth in the above description for purposes of illustration but not of limitation, such as particularities of system structures, interfaces, techniques, et cetera. However, it should be appreciated by those of skill in the art that, in absence of these specific details, the disclosure may also be achieved by other implementations. In other instances, a detailed description of well-known devices, circuits, and methods is omitted, so as to avoid unnecessary details from hindering the description of the disclosure.

1. A mobile terminal-based method of controlling smart home appliances, comprising:
receiving, by a mobile terminal, a current user state, the current user state being selected from user states of a predetermined state group, the current user state being determined by an accessory of the mobile terminal monitoring user sign parameters or environmental parameters in combination with one or more correspondences between the user sign parameters or environmental parameters and the states of the user;
obtaining a current operating mode of at least one smart home appliance, the current operating mode being selected from a predetermined operating-mode group comprising a normal mode and a sleep mode;
determining whether the current operating mode of the at least one smart home appliance matches the current user state, wherein the predetermined state group has a one-to-one correspondence with the predetermined operating-mode group; and
adjusting the current operating mode of the at least one smart home appliance according to the current user state when the current operating mode of the at least one smart home appliance doesn't match the current user state.

2. The method according to claim 1, wherein the adjusting the current operating mode of the at least one smart home appliance comprises: adjusting the current operating mode of the at least one smart home appliance to the sleep mode when the current user state is a sleep state and the at least one smart home appliance is in the normal mode.

3. The method according to claim 1, wherein the adjusting the current operating mode of the at least one smart home appliance further comprises: adjusting the current operating mode of the at least one smart home appliance to the normal mode when the current user state is a non-sleep state and the at least one smart home appliance is in the sleep mode.

4. The method according to claim 2, wherein the at least one smart home appliance comprises at least one of a television, speakers, lights, and an air conditioner; and
the method further comprises adjusting the operating mode of the at least one smart home appliance to the sleep mode comprises: turning down a volume of the TV or speakers, reducing a brightness of the lights, or turning down the power to the air conditioner.

5.-7. (canceled)

8. A mobile terminal comprising a transceiver, a memory, and a processor, wherein
the transceiver is configured to receive a current user state of a plurality of user states, the current user state being obtained through an accessory of the mobile terminal monitoring user sign parameters or environmental parameters;
the memory is configured to store data; and
the processor is configured to: obtain current operating mode of a plurality of operating modes of at least one smart home appliance; determine whether the current operating mode of the at least one smart home appliance matches a current user state, wherein the user states have a one-to-one correspondence with the operating modes of the at least one smart home appliance; and adjust the current operating mode of the at least one smart home appliance based on the current user state when the current operating mode of the at least one smart home appliance doesn't match the current user state.

9. The mobile terminal according to claim 8, wherein the processor is further configured to adjust the current operating mode of the at least one smart home appliance to a sleep mode when the user is in a sleep state and the at least one smart home appliance is in a normal mode.

10. The mobile terminal according to claim 9, wherein the processor is further configured to adjust the current operating mode of the at least one smart home appliance to a normal mode when the user is in a non-sleep state and the at least one smart home appliance is in a sleep mode.

11. The mobile terminal according to claim 8, wherein the at least one smart home appliance comprises at least one of a television, speakers, lights, and an air conditioner; and
the processor is further configured to turn down a volume of the TV or speakers, reduce a brightness of the lights, or turn down the power to the air conditioner, when the user is in a sleep state.

12. An accessory of a mobile terminal, the accessory comprising a transceiver and a processor, wherein
the processor is configured to monitor user sign parameters or environmental parameters, and determine a current user state of the user states based on the user sign parameters or environmental parameters; and
the transceiver is configured to transmit the current user state determined by the processor to the mobile terminal, so that the mobile terminal determines whether to adjust a current operating mode of at least one smart home appliance based on the current user state.

13. The accessory according to claim 12, wherein the processor is further configured to determine the current user state based on the user sign parameters or environmental parameters in combination with correspondences between the user sign parameters or environmental parameters and user states.

14. The accessory according to claim 12, wherein the transceiver is configured to transmit the current user state to the mobile terminal in real time or periodically according to a predetermined period, or transmit the current user state when determining changes to the current user state.

15. The method according to claim 1, wherein the receiving the current user state comprises:
receiving the current user state from the accessory in real time or periodically according to a predetermined period, or receiving the current user state when the current user state changes.

16. The method according to claim 1, further comprising:
storing in advance the correspondences between the user sign parameters or environmental parameters and the user states, or a survey report of the correspondences between the user sign parameters or environmental parameters and the user states into a database.

17. The mobile terminal according to claim 8, wherein the transceiver is further configured to receive the current user state from the accessory in real time or periodically according to a predetermined period, or receive the current user state when the current user state changes.

18. The accessory according to claim 12, wherein the processor is further configured to monitor the user sign parameters or environmental parameters using a sensor.

19. The accessory according to claim 12, wherein the processor is further configured to store in advance the correspondences between the user sign parameters or environmental parameters and the user states, or a survey report of the correspondences between the user sign parameters or environmental parameters and the user states into a database.

20. The accessory according to claim 12, wherein the accessory comprises a wearable device.

21. The accessory according to claim 12, wherein the at least one smart home appliance comprises at least one of a television, speakers, lights, and air conditioner.
